(19) United States
(12) Patent Application Publication
(10) Pub. No.: US 2004/0158622 A1
(43) Pub. Date: Aug. 12, 2004

(54) Auto-sizing channel

(76) Inventor: William M. Pitts, Los Altos, CA (US)

Correspondence Address: Donald E Schreiber, Donald E Shreiber A Professional Corporation, Post Office Box 2926, Kings Beach, CA, 96143-2926, US

(21) Appl. No.: 10/477,552

(22) PCT Filed: May 16, 2002
(86) PCT No.: PCT/US02/15476

(51) Int. Cl. G06F 15/177

(52) U.S. Cl. 709/220

(57) ABSTRACT

A method for allocating resources throughout a digital computer network (20) for efficiently transmitting file data across the network. The network of digital computers (20) permit a first digital computer (24, 26B) to access through at least one intermediate digital computer (26B, 26A) a file that is stored at a second digital computer (22). The method includes the steps of: an upstream digital computer (24, 26B) and an intermediate digital computer (26B, 26A) negotiating a final first MTU size (166) that is used for transfers of file data (164) between the intermediate (26B, 26A) and upstream (24, 26B) digital computers; and the intermediate digital computer (26B, 26A) and a downstream digital computer (26A, 22) negotiating a final second MTU size (166) that is used for transfers of file data (164) between the downstream (26A, 22) and intermediate (26B, 26A) digital computers.

The present invention relates generally to the technical field of distributed file systems technology, and, more particularly, to configuring file transfers across a network of digital computers so transfers between pairs of digital computers in the network are performed efficiently.

### BACKGROUND ART

U.S. Pat. Nos. 5,611,049, 5,892,914, 6,026,452, 6,085,234 and 6,205,475 disclose methods and devices used in a networked, multi-processor digital computer system for caching images of files at various computers within the system. All five (5) United States patents are hereby incorporated by reference as though fully set forth here.

FIG. 1 is a block diagram depicting such a networked, multi-processor digital computer system of the type identified above that is referred to by the general reference character 20. The digital computer system 20 includes a Network Distributed Cache (“NDC”) server site 22, an NDC client site 24, and a plurality of intermediate NDC sites 26A and 26B. Each of the NDC sites 22, 24, 26A and 26B in the digital computer system 20 includes a processor and random access memory (“RAM”), neither of which are illustrated in FIG. 1. Furthermore, the NDC server site 22 includes a disk drive 32 for storing data that may be accessed by the NDC client site 24. The NDC client site 24 and the intermediate NDC site 26B both include their own respective hard disks 34 and 36. A client workstation 42 communicates with the NDC client site 24 via an Ethernet, 10BaseT or other type of Local Area Network (“LAN”) 44 in accordance with a network protocol such as a Server Message Block (“SMB”), Network File System (“NFS®”), Hyper-Text Transfer Protocol (“HTTP”), Netware Core Protocol (“NCP”), or other network-file-services protocol.

Each of the NDC sites 22, 24, 26A and 26B in the networked digital computer system 20 includes an NDC 50 depicted in an enlarged illustration adjacent to intermediate NDC site 26A. The NDCs 50 in each of the NDC sites 22, 24, 26A and 26B include a set of computer programs and a data cache located in the RAM of the NDC sites 22, 24, 26A and 26B. The NDCs 50 together with Data Transfer Protocol (“DTP”) messages 52, illustrated in FIG. 1 by the lines joining pairs of NDCs 50, provide a data communication network by which the client workstation 42 may access data on the disk drive 32 via the chain of NDC sites 24, 26B, 26A or 22 NDC sites 24, 26B, 26A and 22.

The NDCs 50 operate on a data structure called a “dataset.” Datasets are named sequences of bytes of data that are addressed by:

a server-id that identifies the NDC server site where source data is located, such as NDC server site 22; and

a dataset-id that identifies a particular item of source data stored at that site, usually on a hard disk, such as the disk drive 32 of the NDC server site 22.

Topology of an NDC Network

An NDC network, such as that illustrated in FIG. 1 having NDC sites 22, 24, 26A and 26B, includes:

1. all nodes in a network of processors that are configured to participate as NDC sites; and

2. the DTP messages 52 that bind together NDC sites, such as NDC sites 22, 24, 26A and 26B.

Any node in a network of processors that possesses a megabyte or more of surplus RAM may be configured as an NDC site. NDC sites communicate with each other via the DTP messages 52 in a manner that is compatible with non-NDC sites.

The series of NDC sites 22, 24, 26A and 26B depicted in FIG. 1 are linked together by the DTP messages 52 to form a chain connecting the client workstation 42 to the NDC server site 22. The NDC chain may be analogized to an electrical transmission line. The transmission line of the NDC chain is terminated at both ends, i.e., by the NDC server site 22 and by the NDC client site 24. Thus, the NDC server site 22 may be referred to as an NDC server terminator site for the NDC chain, and the NDC client site 24 may be referred to as an NDC client terminator site for the NDC chain. An NDC server terminator site 22 will always be the node in the network of processors that “owns” the source data structure. The other end of the NDC chain, the NDC client terminator site 24, is the NDC site that receives requests from the client workstation 42 to access data on the NDC server site 22.

Data being written to the disk drive 32 at the NDC server site 22 by the client workstation 42 flows in a “downstream” direction indicated by a downstream arrow 54. Data being loaded by the client workstation 42 from the disk drive 32 at the NDC server site 22 is pumped “upstream” through the NDC chain in the direction indicated by an upstream arrow 56 until it reaches the NDC client site 24. When data reaches the NDC client site 24, it together with metadata is reformatted into a reply message in accordance with the appropriate network protocol such as one of the protocols identified previously, and sent back to the client workstation 42. NDC sites are frequently referred to as being either upstream or downstream of another NDC site. If consistent images of files are to be projected from NDCs 50 operating as server terminators to other NDCs 50 throughout the digital computer system 20, the downstream NDC site 22, 26A or 26B must be aware of the types of activities being performed at its upstream NDC sites 26A, 26B or 24.

As described in the patents identified above, for the networked digital computer system 20 depicted in FIG. 1, a single request by the client workstation 42 to read data stored on the disk drive 32 is serviced as follows.

1. The request flows across the LAN 44 to the NDC client terminator site 24 which serves as a gateway to the chain of NDC sites 24, 26B, 26A and 22. Within the NDC client terminator site 24, NDC client intercept routines 102, illustrated in greater detail in FIG. 2, inspect the request. If the request is expressed in one of the various protocols identified previously and if the request is directed at any NDC sites 24, 26B, 26A or 22 for which the NDC client terminator site 24 is a gateway, then the request is intercepted by the NDC client intercept routines 102.

2. The NDC client intercept routines 102 converts the network protocol request into a DTP request, and then submits the request to an NDC core 106.

3. The NDC core 106 in the NDC client terminator site 24 receives the request and checks its NDC cache to determine if the requested data is already present there. If all data is present in the NDC cache of the NDC client terminator site 24, the NDC 50 will copy the data into a reply message structure and immediately respond to the calling NDC client intercept routines 102.

4. If all the requested data isn't present in the NDC cache of the NDC client terminator site 24, then the NDC 50 of the NDC client terminator site 24 accesses elsewhere any missing data. If the NDC client terminator site 24 were a server terminator site, then the NDC 50 would access the file system for the hard disk 34 upon which the data would reside.

5. Since the NDC client site 24 is a client terminator site rather than a server terminator site, the NDC 50 must request the data it needs from the next downstream NDC site, i.e., intermediate NDC site 26B in the example depicted in FIG. 1. Under this circumstance, DTP client interface routines 108, illustrated in FIG. 2, are invoked to request from the intermediate NDC site 26B whatever additional data the NDC client terminator site 24 needs to respond to the current request.

6. A DTP server interface routine 104, illustrated in FIG. 2, at the downstream intermediate NDC site 26B receives the request from the NDC 50 of the NDC client terminator site 24 and the NDC 50 of this NDC site processes the request according to steps 3, 4, and 5 above. The preceding sequence repeats for each of the NDC sites 24, 26B, 26A and 22 in the NDC chain until the request reaches the server terminator, i.e., NDC server site 22 in the example depicted in FIG. 1, or until the request reaches an intermediate NDC site that has cached all the data that is being requested.

7. When the NDC server terminator site 22 receives the request, its NDC 50 accesses the source data structure. If the source data structure resides on a hard disk, the appropriate file system code (UFS, DOS, etc.) is invoked to retrieve the data from the disk drive 32.

8. When the file system code on the NDC server terminator site 22 returns the data from the disk drive 32, a response chain begins whereby each downstream site successively responds upstream to its client, e.g. NDC server terminator site 22 responds to the request from intermediate NDC site 26A, intermediate NDC site 26A responds to the request from intermediate NDC site 26B, etc.

9. Eventually, the response percolates up through the sites 22, 26A, and 26B to the NDC client terminator site 24.

10. The NDC 50 on the NDC client terminator site 24 returns to the calling NDC client intercept routines 102, which then packages the returned data and metadata into an appropriate network protocol format, such as that for one of the various, previously identified network protocols, and sends the data and metadata back to the client workstation 42.

The NDC 50

As depicted in FIG. 2, the NDC 50 includes five major components:

NDC client intercept routines 102;

DTP server interface routine 104;

NDC core 106;

DTP client interface routines 108; and

file system interface routines 112.

Routines included in the NDC core 106 implement the function of the NDC 50. The other routines 102, 104, 108 and 112 supply data to and/or receive data from the NDC core 106. FIG. 2 illustrates that the NDC client intercept routines 102 are needed only at NDCs 50 which may receive requests for data in a protocol other than DTP, e.g. one of the various, previously identified network protocols. The NDC client intercept routines 102 are responsible for conversions necessary to interface a projected dataset image to a request that has been submitted via any of the industry standard protocols supported at the NDC sites 24, 26B, 26A or 22.

The file system interface routines 112 are necessary in the NDC 50 only at the NDC server terminator site 22, or in NDCs 50 which include a disk cache such as on the hard disks 34 and 36. The file system interface routines 112 route data between the disk drives 32A, 32B and 32C illustrated in FIG. 2 and a data conduit provided by the NDCs 50 that extends from the NDC server terminator site 22 to the NDC client terminator site 24.

If the NDC client intercept routines 102 of the NDC 50 receives a request to access data from a client, such as the client workstation 42, it prepares a DTP request indicated by an arrow 122 in FIG. 2. If the DTP server interface routine 104 of the NDC 50 receives a request from an upstream NDC 50, it prepares a DTP request indicated by the arrow 124 in FIG. 2. The DTP requests 122 and 124 are presented to the NDC core 106. Within the NDC core 106, the request 122 or 124 cause a buffer search routine 126 to search a pool 128 of NDC buffers 129, as indicated by the arrow 130 in FIG. 2, to determine if all the data requested by either the routines 102 or 104 is present in the NDC buffers 129 of this NDC 50. If all the requested data is present in the NDC buffers 129, the buffer search routine 126 prepares a DTP response, indicated by the arrow 132 in FIG. 2, that responds to the request 122 or 124, and the NDC core 106 appropriately returns the DTP response 132, containing both data and metadata, either to the NDC client intercept routines 102 or to the DTP server interface routine 104 depending upon which routine 102 or 104 submitted the request 122 or 124. If the NDC client intercept routines 102 receives DTP response 132, before the NDC client intercept routines 102 returns the requested data and metadata to the client workstation 42 it reformats the response from DTP to the protocol in which the client workstation 42 requested access to the dataset, e.g. into one of the various, previously identified network protocols.

If all the requested data is not present in the NDC buffers 129, then the buffer search routine 126 prepares a DTP downstream request, indicated by the arrow 142 in FIG. 2, for only that data which is not present in the NDC buffers 129. A request director routine 144 then directs the DTP request 142 to the DTP client interface routines 108, if this NDC 50 is not located in the NDC server terminator site 22, or to the file system interface routines 112, if this NDC 50 is located in the NDC server terminator site 22. After the DTP client interface routines 108 obtains the requested data together with its metadata from a downstream NDC site 22, 26A, etc. or the file system interface routines 112 obtains the data from the file system of this NDC client terminator site 24, the data is stored into the NDC buffers 129 and the buffer search routine 126 returns the data and metadata either to the NDC client intercept routines 102 or to the DTP server interface routine 104 as described above.

As described in the patents identified above, in addition to projecting images of a stored dataset, the NDCs 50 detect a condition for a dataset, called a concurrent write sharing (“CWS”) condition, which occurs whenever two or more client sites concurrently access a dataset, and one or more of the client sites attempts to write the dataset. If a CWS condition occurs, one of the NDC sites, such as the NDC sites 22, 24, 26A and 26B in the digital computer system 20, declares itself to be a consistency control site (“CCS”) for the dataset, and imposes restrictions on the operation of other NDCs 50 upstream from the CCS. The operating restrictions that the CCS imposes upon upstream NDCs 50 guarantee throughout the network of digital computers that client sites, such as the client workstation 42, have the same level of file consistency as they would have if all the client sites operated on the same computer. That is, the operating conditions that the CCS imposes ensure that modifications made to a dataset by one client site are reflected in the subsequent images of that dataset projected to other client sites no matter how far the client site modifying the dataset is from the client site that subsequently requests access to the dataset.

As described in the United States patents identified above, within each NDC 50 there exist a data structure called a “channel” which is associated with each dataset that is being cached at the NDC sites 22, 24, 26A and 26B. Each channel functions as a conduit through the NDC 50 for projecting images of data to sites requesting access to the dataset. Channels may also store an image of the data in the NDC buffers 129 at each NDC site. Channels of each NDC 50 acquire NDC buffers 129 as needed to cache file images that may be loaded from either a local disk cache or from the immediately preceding downstream NDC 50.

Each channel in the chain of NDC sites 22, 24, 26A and 26B is capable of capturing and maintaining in the site's NDC buffers 129 an image of data that pass through the NDC 50, unless a CWS condition exists for that data. However, each channel is more than just a cache for storing an image of the dataset to which it's connected. The channel contains information necessary to maintain the consistency of the projected images, and to maintain high performance through the efficient allocation of resources. The channel is the basic structure through which both control and data information traverse each NDC sites 22, 24, 26A and 26B, and is therefore essential for processing any request.

Data stored in each channel characterizes the interconnection between a pair NDCs 50 for a particular dataset. If two NDCs 50 share a common main memory or common disk storage, then a physical data transfer doesn't occur between the NDCs 50. Instead, the NDCs 50 exchange pointers to the data. If two NDCs 50 exchange pointers to data stored in a shared RAM, effective throughput bandwidths in excess of 100 gigabytes per second may be attained by passing pointers to very large NDC buffers 129, e.g. 64 M byte NDC buffers 129. If two NDCs 50 share disk storage, e.g. via a storage area network (“SAN”) or InfiniBand, file extent maps become metadata which may be cached at both NDCs 50. Under such circumstances, an upstream NDC 50 communicates with a downstream NDC 50 to establish a file connection and load the file's extent map from the downstream NDC 50. Either NDC 50 may then transfer data directly to/from the shared disk without contacting the other NDC 50 unless one of the NDC 50 attempts to write the file.

While the United States patents identified above disclose how images of files may be cached at various computers within the digital computer system 20 and how operation of NDCs 50 preserve consistent images of the files throughout the digital computer system 20, those patents fail to disclose that the NDC buffers 129 may be of differing sizes, or that two NDCs 50 may negotiate the maximum transfer unit (“MTU”) size to be used for data transfers between channels located at the two NDCs 50. While certain versions of some network protocols, e.g. NFS versions 3 and 4, disclose a possibility that a client digital computer and a server digital computer might negotiate in establishing a MTU size used for transfers between them, such protocols permit negotiations to occur only directly between client and server computers.

The size of block data transfers between a server digital computer and a client digital computer interacts with the memory management scheme of the operating system (“OS”) that controls the operation of the digital computers. For example, Sun Microsystems, Inc.'s Solaris OS manages a digital computer's RAM in fixed size, 4 k byte, pages. A computer program's request for a single 2.0 megabyte (“MB”) page of contiguous virtual memory (“VM”) requires that the Solaris OS allocate five-hundred and twelve (512) individual pages and then “glue” them together into the single, contiguous 2.0 MB page of VM address space. Assembling the 2.0 MB page is a time consuming operation for the Solaris OS. When the computer program subsequently releases the 2.0 MB page, the Solaris OS must break the page up and return all five-hundred and twelve (512) individual pages to the OS' free memory pools. In general, OSs manage memory in this way although among OSs the page size varies from the 4 K byte page size of the Solaris OS.

As is readily apparent to those skilled in the art, specifying only one MTU size for blocks of data transferred across a network of digital computers does not fit all files, or all digital computers in a heterogeneous network. For example, one file may be very small which could waste space if blocks were used for transferring data between a pair of digital computers that have a large extent. Conversely, another file may be very large which could impose a significant data transmission overhead if small blocks were used for transferring data between a pair of digital computers. Analogously, the data transmission capacity of a connection between a pair of digital computers in the network, and/or the resources available at one or both of the computers in such a pair might be, respectively, under utilized or over taxed if too large or too small an extent were selected for block data transfers between the pair of digital computers. Moreover, for a particular file, depending upon specific characteristics of the network of digital computers, a fixed extent for data blocks received by a particular computer, which extent is well suited for transferring data between a transmitting digital computer and the particular digital computer, might be inefficient for data blocks from the same file that are subsequently transferred from the particular computer to a different receiving digital computer.

An object of the present invention is to facilitate transferring files across a network of digital computers.

Another object of the present invention is to adapt each file transfer across a network of digital computers so characteristics of the file transfer are individually configured for each pair of digital computers in the network.

Briefly, the present invention is a method for allocating resources throughout a digital computer network for efficiently transmitting file data across the network. The network of digital computers permit a first digital computer to access through at least one intermediate digital computer a file that is stored at a second digital computer in the network of digital computers. The first digital computer is adapted for retrieving from the second digital computer and for storing a cached image of the file. The method of the present invention for effecting a transmission of file data efficiently through the network of digital computers includes the steps of:

1. an upstream digital computer and an intermediate digital computer negotiating a final first MTU size that is used for transfers of file data between the intermediate and upstream digital computers; and

2. the intermediate digital computer and a downstream digital computer negotiating a final second MTU size that is used for transfers of file data between the downstream and intermediate digital computers.

An advantage of the present invention is that the negotiation between a pair of NDCs 50 for an extent value enables scaling data transfer operations to a level appropriate for the type of communication link that interconnects two NDCs 50, and for the resources currently available at both NDCs 50.

These and other features, objects and advantages will be understood or apparent to those of ordinary skill in the art from the following detailed description of the preferred embodiment as illustrated in the various drawing figures.

### BRIEF DESCRIPTION OF DRAWINGS

FIG. 1 is a block diagram illustrating a prior art networked, multi-processor digital computer system that includes an NDC server terminator site, an NDC client terminator site, and a plurality of intermediate NDC sites, each NDC site in the networked computer system operating to permit the NDC client terminator site to access data stored at the NDC server terminator site;

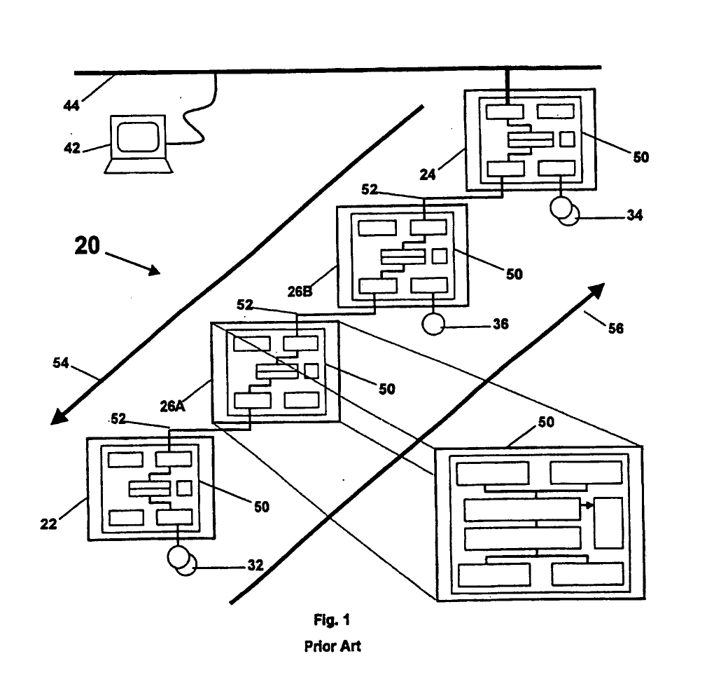

FIG. 2 is a block diagram illustrating a structure of the prior art NDC included in each NDC site of FIG. 1 including the NDC's buffers;

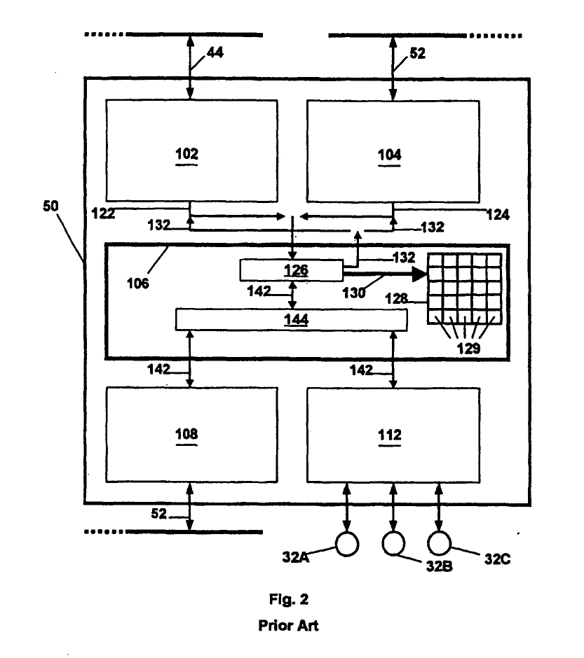

FIG. 3 is a block diagram illustrating a relationship that exists between transfer of file data between NDC sites and data stored in accordance with the present invention in NDC buffers at the NDC site that receives the file data;

FIG. 4 is a block diagram illustrating successive subdivisions of an NDC buffer thereby adapting that NDC buffer for efficiently storing progressively smaller blocks of file data; and

FIG. 5 is a diagram illustrating lists that are used in managing the subdivision of NDC buffers for efficiently storing progressively smaller blocks of file data.

### BEST MODE FOR CARRYING OUT THE INVENTION

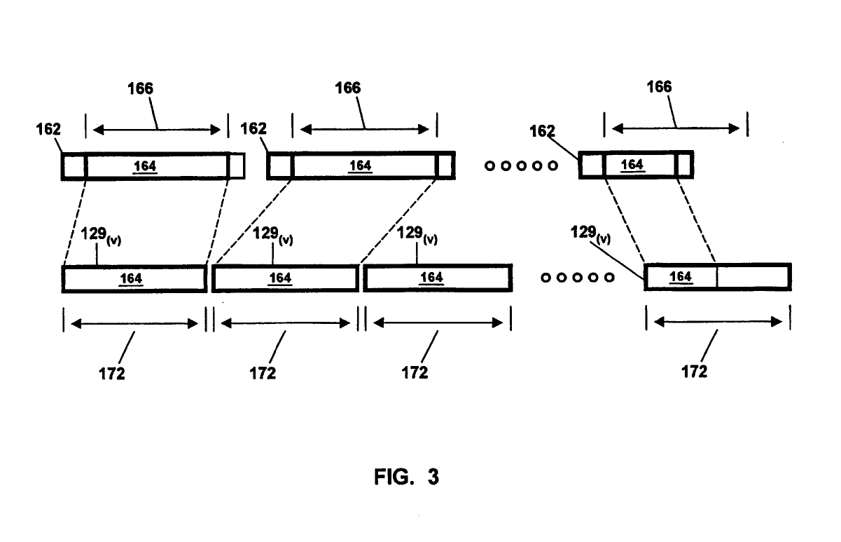

The block diagram of FIG. 3 in the upper half illustrates a sequence of transfers 162 of file data such as occur between an immediately adjacent pair of NDCs 50. Proceeding from left to right in FIG. 3, except for the right hand transfer 162 each of the transfers 162 includes an amount of file data 164 that equals the MTU size 166, indicated in FIG. 3 by a double headed arrow. The right hand transfer 162 illustrates transferring an amount of file data 164 that is less than the MTU size 166, an event which usually occurs for the last transfer 162 of a file's data. The sequence of file data 164 in the lower half of FIG. 3 illustrates segmentation of the file for storage in individual NDC buffers 129.

As described in the United States patents identified above, the data of a cached file image projection is stored within the NDC buffers 129 that the NDC 50 assigns to a channel as needed. Each of the NDC buffers 129 has an extent value 172, indicated in FIG. 3 by a double headed arrow. As distinguished from the United States patents identified above, in accordance with the present invention the extent value 172 may be assigned differing values depending upon the type of communication link that interconnects two NDCs 50, and on the resources currently available at both NDCs 50. Moreover, in accordance with the present invention a negotiation between immediately adjacent NDCs 50 determines a value for the extent value 172 that is an integral multiple of, such as equal to, the MTU size 166. In one alternative embodiment of the present invention:

1. the extent value 172 may be assigned one of five (5) different values;

2. each of these five (5) extent values 172 differs by a multiple of sixteen (16) from the next larger and the next smaller extent value 172; and

3. the smallest of the five (5) extent values 172 is 1 k byte and the largest of the five (5) extent values 172 is 64 M bytes.

During the process by which an NDC client terminator site 24 accesses a dataset stored at an NDC server terminator site 22, while each successive upstream NDC 50 is establishing a connection for the dataset with a downstream NDC 50, the two NDCs 50 negotiate an extent value 172 that will be used for the NDC buffers 129 to be assigned to the channel at the upstream NDC 50. In commencing the negotiation, a first upstream NDC 50, usually at an NDC client terminator site 24, initially proposes a “generous” extent value 172 to an immediately adjacent downstream NDC 50. If the immediately adjacent downstream NDC 50 does not possess cached valid metadata for the dataset, that NDC 50, acting as a second upstream NDC 50 attempting to access the dataset, before responding to the negotiation commenced by its upstream NDC 50 may commence a negotiation with another downstream NDC 50, that is closer to the NDC server terminator site 22 for the dataset. The preceding negotiation process continues progressively through a sequence of NDCs 50 getting ever closer to the NDC server terminator site 22 for the dataset until reaching an NDC 50 which possesses cached valid metadata for the dataset. In a “worst case” scenario, the NDC 50 at the NDC server terminator site 22 ultimately provides valid metadata for the dataset. Once the request to establish a connection to the dataset reaches an NDC 50 which possesses valid metadata for the dataset, that NDC 50 either:

1. accepts the extent value 172 proposed by the immediately adjacent upstream NDC 50; or

2. the downstream NDC 50 responds with a smaller extent value 172 that is compatible with:

a. characteristics of the dataset, e.g. if the dataset is smaller than the extent value 172 proposed by the immediately adjacent upstream NDC 50; or

b. resources available at the NDC 50 which possesses cached valid metadata for the dataset.

When a downstream NDC 50 responds to the extent value 172 negotiation initiated by its immediately adjacent upstream NDC 50, the extent value 172 specified by the downstream NDC 50 becomes the extent value 172 for all data transfers between that pair of NDCs 50. The upstream NDC 50 also uses the extent value 172 established by this negotiation as:

1. the basic unit by which the upstream NDC 50 allocates NDC buffers 129 to the dataset's channel; and

2. the size for all full block data transfers between the pair of NDCs 50 for the dataset.

Once established in this way, the extent value 172 remains fixed while the file connection exists between the pair of NDCs 50. The preceding extent value 172 negotiation enables a sequence of NDCs 50 to automatically configure both their internal resource allocations and their external data transfer operations to levels appropriate for the type of communication links interconnecting them, and to the digital computer resources existing throughout the sequence of NDCs 50. During an extent value 172 (MTU size 166) negotiation, a downstream NDC 50 may accommodate an upstream NDC 50 by accepting an MTU size 166 that is larger than the extent value 172 for its local NDC buffers 129 that store the file data and from which the downstream NDC 50 ultimately transmits file data to the upstream NDC 50.

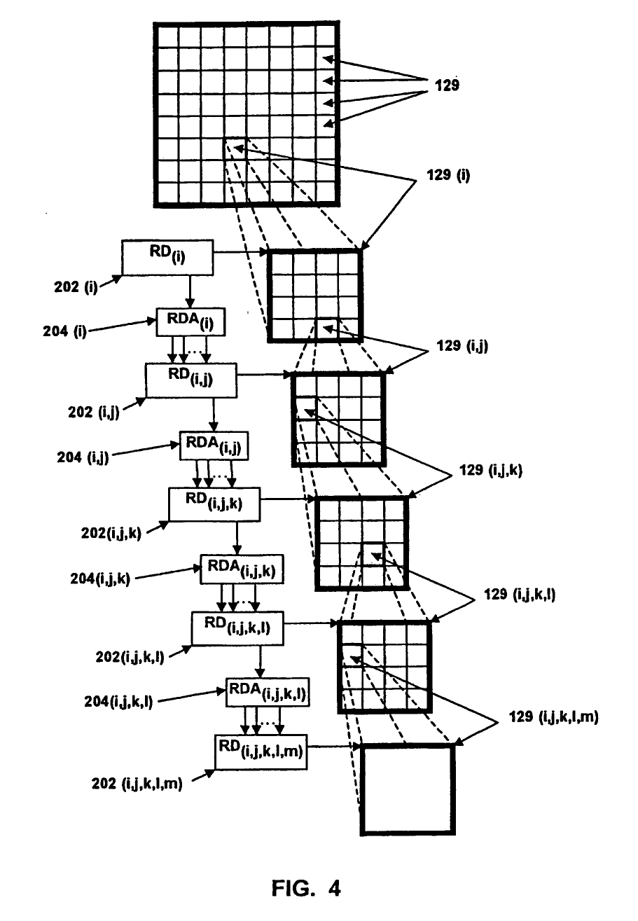

As illustrated in FIG. 4, each NDC buffer 129 at each NDC 50 is preferably organized to include a four (4) level hierarchy of regions each of which may be further subdivided. The hierarchy also includes a fifth and lowest level region that cannot be further subdivided. While in the illustration of FIG. 4, the NDC buffers 129 and each of the subdividable regions therein are depicted as being rectangular, for pedagogical simplicity the following description uniquely identifies each region in the NDC buffers 129 by single integer indices, e.g. (i), rather than by a pair of integer indices, e.g. (i, j). Thus, each of the NDC buffers 129 depicted in FIG. 4 can be uniquely identified as NDC buffer 129₍ᵢ₎, where i is an integer between 1 and the number of NDC buffers 129 at the NDC 50. Regions in a first level subdivision of NDC buffer 129₍ᵢ₎ are uniquely identified by a two (2) integer index, e.g. NDC buffer 129_{(i, j)}, where j is an integer between 1 and the number of sub-regions into which NDC buffer 129_{(i, j)} may be subdivided. This successive subdivision process continues down to regions in the second level subdivision of NDC buffer 129₍ᵢ₎ which are uniquely identified by a three (3) integer index, e.g. NDC buffer 129_{(i, j, k)}, where k is an integer between 1 and the number of sub-regions into which NDC buffer 129 _{(i, j)} may be subdivided. This successive subdivision of regions in the NDC buffer 129₍ᵢ₎ continues until reaching the fifth and non-further subdividable lowest level region, i.e. NDC buffer 129_{(i, j, k, l, m)}.

Each region in the hierarchy is described by a region descriptor (“RD”) 202_{(V)}, where V is a vector having a number of components, e.g. (i, j, . . . ), sufficient to specify precisely a particular NDC buffer 129₍ᵢ₎ or subdivision of the NDC buffer 129₍ᵢ₎. A table set forth below depicts a preferred structure for the RD 202_{(V)}. Data stored in the RD 202_{(V)} may be flagged as X_DIRECT, in which instance data stored in “rp” in the RD 202_{(V)} points directly to the first byte of a region capable of storing an amount of data specified by an extent value 172 that is stored in “extlen” in the RD 202_{(V)}. Alternatively, data stored in the RD 202_{(V)} may be flagged as X_INDIRECT, in which instance data stored in “rp” in the RD 202_{(V)} points to a region descriptor array (“RDA”) 204_{(V)}. Each entry in the RDA 204_{(V)} points to an RD 202_{(V)} that contains data which describes and is used in managing part of the NDC buffer 129 assigned to the next lower subdivided level of the NDC buffer 129₍ᵢ₎, i.e. NDC buffer 129 _{(V)}. The lowest level RD 202_{(V)} can never be indirect, i.e. “rp” in its RD 202_{(V)}. e.g. RD 202_{(i, j, k, l, m)}:

1. points directly to the first byte of a region capable of storing an amount of data specified by an extent value 172 that is stored in the RD 202_{(i, j, k, l, m)}; and

2. does not point to an RDA 204_{(i, j, k, l, m)}.

Region Descriptor 202₍ᵥ₎

| | | |
|---|---|---|
| rd | *crl_forw; | Channel list pointers |
| rd | *crl_back; | |
| rd | *frl_forw; | Free list pointers |
| rd | *frl_back; | |
| channel | *cp; | A pointer to the channel to which |
| | | NDC buffer 129₍ᵥ₎ is assigned. |
| rd | *prd; | Parent region descriptor pointer |
| DDS_RV | rv; | A Region Vector that uniquely |
| | | identifies the NDC buffer 129₍ᵥ₎ |
| | | and its position in the hierarchy |
| | | of NDC buffers 129. |
| | | vec.level - extent level |
| | | vec.x[N_LEVELS] - rda indices |
| u_long | r_ctime; | time when queued on Channel list |
| u_long | r_dtime; | dirty time |
| u_long | r_btime; | channel busy time |
| u_long | flags; | Flags: DIRECT, INDIRECT |
| rwlock_t | extlock; | Multiple readers/single writer |
| | | lock |
| quad | extbase; | File offset of 1st virtual region |
| | | byte |
| quad | extoff; | File offset within the region of |
| | | 1st valid byte |
| u_long | extlen; | Number of valid bytes in the |
| | | region |
| RATE | rate; | Data flow rate into/out of this |
| | | region. |
| VMExt | *vmptr; | region address |

| | |
|---|---|
| union { | DIRECT: physical address of 1st |
| void *d; | byte |
| DDS_RDA *i; | INDIRECT: region descriptor array |
| } rp; | (rda) pointer |

The number of hierarchical levels into which each NDC buffer 129 may be subdivided, and the extent value 172 for each hierarchical level can be dynamically configured during initialization of each NDC 50. During initialization, each NDC 50 obtains from the OS a large block of RAM to be used for the NDC buffers 129. After allocating the large block of RAM, the NDC 50 thereafter:

1. manages, in the way described in greater detail below, all subdivision of and allocation of the RAM for use as NDC buffers 129_{(V)}; and

2. controls whether a VM facility provided by the OS pages any portion of the RAM so allocated out of or into the digital computer's physical RAM.

As described above, each NDC 50:

1. configures the RAM allocated for the NDC buffers 129 for subdivision into some number of hierarchical levels, perhaps five (5); and

2. the extent value 172 of each level differs by some multiple, e.g. sixteen (16), from the next larger and the next smaller extent value 172 in the hierarchy.

Using the preceding organization for a hierarchical subdivision of each NDC buffer 129_{(V)}, a table set forth below specifies the subdivision factor and extent values 172 at each level in the hierarchy illustrated in FIG. 4 as described above for 2 M byte NDC buffers 129₍ᵢ₎.

| | Subdivision | Extent | |
|---|---|---|---|
| | Factor | Value | |
| NDC buffer 129₍ᵢ₎ | 16 | 2M | bytes |
| NDC buffer 129_{(i j)} | 16 | 128k | bytes |
| NDC buffer 129_{(i, j, k)} | 16 | 8k | bytes |
| NDC buffer 129_{(i, j, k, l)} | 16 | 512 | bytes |
| NDC buffer 129_{(i, j, k, l, m)} | 0 | 32 | bytes |

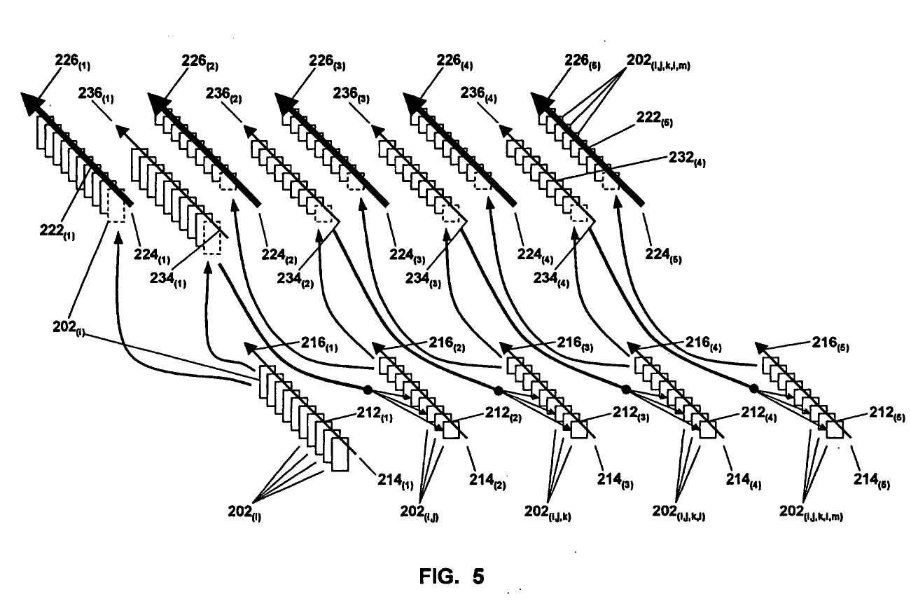

All NDC buffers 129_{(V)}, regardless of their level in the hierarchy, are linked by RDs 202_{(V)} to lists of differing types. For the preceding embodiment of the invention in which NDC buffer 129 _{(V)} has five (5) different subdivision levels, as depicted in FIG. 5 there are five (5) sets of lists. Within each different type of list, a particular list may be uniquely identified by an integer n having an appropriate value of 1 to 5 for the particular embodiment of the present invention being described herein.

Immediately after the NDC 50 allocates the large block of RAM from the OS and initializes it, RDs 202₍ᵢ₎ for all the NDC buffers 129₍ᵢ₎ are linked together on an anonymous region list 212₍₁₎ illustrated by an arrow in FIG. 5 The anonymous region list 212₍₁₎ includes a tail 214₍₁₎ and a head 216₍₁₎. The NDC 50 pre-allocates NDC buffers 129_{(V)} to hold the data as required.

If the extent value 172 previously negotiated for full blocks of data being received by the NDC 50 is the extent value 172 for NDC buffers 129₍ᵢ₎, then successive NDC buffers 129₍ᵢ₎, specified by RDs 202₍ᵢ₎ that are located at the head 216₍₁₎ of the anonymous region list 212₍₁₎, are assigned to store each successive block of data. As each NDC buffer 129₍ᵢ₎ identified by the RD 202₍ᵢ₎ at the head 216₍₁₎ of the anonymous region list 212₍₁₎ is used for storing data, that RD 202₍ᵢ₎ is moved from the head 216₍₁₎ of the anonymous region list 212₍₁₎ and momentarily assigned to the requesting channel. After the channel responds to the current request from an upstream NDC 50, the RD 202 ₍ᵢ₎ is queued at a tail 224₍₁₎ of a least recently used (“LRU”) managed free region list 222₍₁₎ that also has a head 226₍₁₎.

The free region lists 222₍ₙ₎ are called “free” because at any instant the RDs 202 _{(V)} assigned to them identify NDC buffers 129_{(V)} that contain valid file data that is not being used at that particular instant. An RD 202_{(V)} is “busy” while it is assigned to a channel during processing of a file access request. When a RD 202_{(V)} is not assigned to a channel, it is considered “free” because the NDC buffer 129_{(V)} identified by the RD 202_{(V)} may be allocated for use for storing different file data during processing of a different file access request. The NDC buffers 129_{(V)} identified by RDs 202_{(V)} that are assigned to anonymous region lists 212_{(V)} may also be allocated for use for storing file data. However, the NDC buffers 129_{(V)} identified by RD 202_{(V)} that are assigned to anonymous region lists 212₍ₙ₎ lack any valid file data.

If the extent value 172 previously negotiated for full blocks of data being received by the NDC 50 is sufficiently smaller than the extent value 172 for NDC buffers 129₍ᵢ₎ then one of the NDC buffers 129₍ᵢ₎ identified by one of the RDs 202₍ᵢ₎ in the anonymous region list 212₍₁₎ must be subdivided until there exists an NDC buffer 129_{(V)} having an extent value 172 that is appropriately sized for receiving full block transfers of data having the negotiated extent value 172. To prepare for subdivision of one of the NDC buffers 129₍ᵢ₎, initially the NDC 50 moves the RD 202₍ᵢ₎ at the head 216₍₁₎ of the anonymous region list 212₍₁₎ from that list to a tail 234₍₁₎ of a subdivided region list 232₍₁₎ that also has a head 236₍₁₎. After the RD 202₍₁₎ has been moved to the tail 234₍₁₎ of the subdivided region list 232₍₁₎, the NDC buffer 129₍₁₎ that it identifies is subdivided into sixteen (16) NDC buffers 129_{(1, j)} by placing onto a tail 214₍₂₎ of an anonymous region list 212₍₂₎ sixteen (16) RDs 202_{(i, j)} each of which specifies a different, contiguous one-sixteenth of the NDC buffer 129₍ᵢ₎.

If the extent value 172 for the RDs 202_{(i, j)} assigned to the anonymous region list 212₍₂₎ remains sufficiently larger than the extent value 172 previously negotiated for full blocks of data being received by the NDC 50, the NDC 50 moves the RD 202_{(i, j)} at the head 216₍₂₎ of the anonymous region list 212₍₂₎ to a tail 234₍₂₎ of a subdivided region list 232₍₂₎. Then, the subdivision process described in the preceding paragraph repeats for the NDC buffer 129_{(i, j)} specified by the RD 202_{(i, j)} that is at the head 236₍₂₎ of the subdivided region list 232₍₂₎. As described above, subdivision of the NDC buffer 129_{(i, j)} is effected by placing sixteen (16) RDs 202_{(i, j, k)} each specifying a different, contiguous one-sixteenth of the NDC buffer 129_{(i, j)} onto a tail 214₍₃₎ of a anonymous region list 212₍₃₎. The preceding process of subdividing NDC buffers 129_{(V)} repeats through successive subdivisions until establishing either:

1. an NDC buffer 129_{(V)} having an extent value 172 which is appropriately sized for receiving full block data transfers from the downstream NDC 50; or

2. an NDC buffer 129_{(i, j, k, l, m)} having the smallest permitted extent value 172.

When the process of subdividing NDC buffers 129_{(V)} concludes for either of the preceding reasons, the NDC 50:

1. assigns to the channel for storage of data received from the downstream NDC 50 the NDC buffer 129_{(V)} having an appropriate extent length that is specified by the RD 202_{(V)} that is located at the head 216₍ₙ₎ of the appropriate anonymous region list 212₍ₙ₎; and

2. moves that RD 202_{(V)} from the head 216₍ₙ₎ of the anonymous region list 212₍ₙ₎ and momentarily assigns it to the requesting channel. After the channel responds to the current request from an upstream NDC 50, the RD 202_{(V)} is queued at the tail 224₍ₙ₎ of the corresponding free region list 222₍ₙ₎.

After the NDC 50 stores file data into na NDC buffer 129_{(V)}, every time the NDC 50 again accesses that file data the corresponding RD 202_{(V)} is removed from the free region list 222₍ₙ₎ and assigned to the channel. When the channel completes processing the request that caused it to acquire the RD 202_{(V)}, the RD 202_{(V)} is queued at the tail 224₍ₙ₎ of the free region list 222₍ₙ₎ to which it belongs. This process which re-positions RDs 202_{(V)} to the tail 224₍ₙ₎ of the free region list 222(,, causes RDs 202_{(V)} for least recently used NDC buffers 129_{(V)} to progressively migrate toward the head 226₍ₙ₎ of the free region list 222₍ₙ₎.

As is readily apparent to those skilled in the art, after the NDC 50 has subdivided to a particular extent value 172 NDC buffers 129_{(V)} and therefore has initially placed sixteen (16) RDs 202_{(V)} onto the appropriate anonymous region list 212₍ₙ₎, the next time the NDC 50 requires an RD 202_{(V)} that has an extent value 172 for which the previously created NDC buffers 129_{(V)} are appropriately sized, while at least one RD 202_{(V)} remains on the appropriate anonymous region list 212ₙ the NDC 50 obtains an unused NDC buffer 129_{(V)} for receiving the data merely by removing the RD 202_{(V)} from the head 216₍ₙ₎ of the anonymous region lists 212₍ₙ₎.

As is also readily apparent to those skilled in the art, if unchecked the subdivision of NDC buffers 129_{(V)} having a particular extent value 172 to obtain NDC buffers 129_{(V)} having a smaller extent value 172 progressively cleaves NDC buffers 129_{(V)} into ever smaller NDC buffers 129_{(V)}. Over an extended interval of time, unchecked subdivision will cause the large block of RAM which the NDC 50 obtained from the OS for the NDC buffers 129 to become very fragmented, which will substantially degrade performance of the NDC 50. To prevent excessive fragmentation of the NDC buffers 129, thresholds are specified limiting the maximum number of RDs 202_{(V)} that can be on each subdivided region list 232₍ₙ₎.

If an NDC buffer 129_{(V)} must be allocated to a channel for responding to a file access request, and if there is no NDC buffer 129_{(V)} identified by an RD 202_{(V)} on the appropriate anonymous region list 212₍ₙ₎, and if the next higher level subdivided region list 232₍₂₋₁₎ has reached the threshold that prevents further subdivision of NDC buffers 129_{(V)} identified by RDs 202_{(V)} on the anonymous region list 212₍ₙ₋₁₎ and on the free region list 222₍ₙ₋₁₎, then the NDC buffer 129_{(V)} identified by the RD 202_{(V)} at the head 226₍ₙ₎ of the free region list 222_{(V)} is assigned to the channel. Correspondingly, if an RD 202_{(V)} gets too close to the head 226₍ₙ₎ of the free region list 222₍ₙ₎, if possible a daemon thread writes the file image to storage such as the hard disk 34 or 36, discards the data stored in the NDC buffer 129_{(V)} identified by the RDs 202_{(V)}, and returns the RD 202_{(V)} to the head 216₍ₙ₎ of the anonymous region list 212₍ₙ₎.

### INDUSTRIAL APPLICABILITY

The present invention operates with equal efficiency for every extent value 172. Whatever extent value 172 an immediately adjacent pair of NDCs 50 negotiate, each NDC 50 in the immediately adjacent pair effects full block data transfers as an integral unit. The key to operating with equal efficiency at every NDC 50 in a sequence of NDCs 50 is managing the NDC buffers 129 so the NDC buffers 129_{(V)}, no matter what their size, are always comprised of a single expanse of contiguous physical RAM. Clearly, if 16 M byte. NDC buffers 129 were composed of 2048 8 k blocks of RAM each of which is acquired individually from the OS and the NDC 50 scattered data of a single 16 megabyte full block data transfer operation into all of those blocks of RAM, the overhead of 16 M byte full block data transfer would be substantially higher than that required for 8 k byte full block data transfers.

For maximum efficiency, all the NDCs 50 in a sequence of NDCs 50 used to access a dataset should be initialized to have congruent extent values 172. That is, for maximum efficiency the sequence of NDCs 50 should be initialized to possess at least one common extent value 172, and preferably a number of common extent values 172.

The present invention does not prevent NDCs 50 from using different extent values 172 when receiving full block transfers for a particular dataset from a downstream NDC 50, and when sending full block transfers for the same dataset to an upstream NDC 50. Thus, for example, a 16 M byte extent value 172 might be appropriate for transmitting a dataset that contains video data from the disk drive 32 at an NDC server terminator site 22 disk into the NDC buffers 129 of that site's NDC 50. If the NDC 50 at the NDC server terminator site 22 were connected to the immediately adjacent upstream NDC 50 by a Gigabit Ethernet, then the NDC 50 at the NDC server terminator site 22 might then negotiate a 1 M byte extent value 172 for full block data transfers from the dataset to the immediately adjacent upstream NDC 50. If further upstream an NDC 50 were connected to the immediately adjacent upstream NDC 50 by a 100 Megabit Ethernet, then the NDC 50 at that site might negotiate an 64 k byte extent value 172 for full block data transfers from the dataset to the immediately adjacent upstream NDC 50.

Although the present invention has been described in terms of the presently preferred embodiment, it is to be understood that such disclosure is purely illustrative and is not to be interpreted as limiting. Consequently, without departing from the spirit and scope of the invention, various alterations, modifications, and/or alternative applications of the invention will, no doubt, be suggested to those skilled in the art after having read the preceding disclosure. Accordingly, it is intended that the following claims be interpreted as encompassing all alterations, modifications, or alternative applications as fall within the true spirit and scope of the invention.

What is claimed is:

1. In a network of digital computers via which a first digital computer thereof accesses through at least one intermediate digital computer a file that is stored at a second digital computer in the network of digital computers; the first digital computer being adapted for retrieving from the second digital computer and for storing a cached image of the file, a method for configuring individual digital computers for efficiently transferring the file through the network of digital computers comprising the steps of:
a) an upstream digital computer and an intermediate digital computer negotiating a final first maximum transfer unit (“MTU”) size that is used for transfers of file data between the intermediate and upstream digital computers; and
b) the intermediate digital computer and a downstream digital computer negotiating a final second MTU size that is used for transfers of file data between the downstream and intermediate digital computers.

2. The method of claim 1 wherein the upstream and intermediate digital computers negotiate the final first MTU size by:
a) the intermediate digital computer receiving from the upstream digital computer a request to access the file together with a proposed first MTU size for possible use for transfers of file data between the upstream and intermediate digital computers; and
b) the intermediate digital computer transmitting to the upstream digital computer the final first MTU size which the intermediate and upstream digital computers use for transfers of file data between the intermediate and upstream digital computers.

3. The method of claim 2 further comprising the step of the upstream digital computer establishing an extent value, which equals the final first MTU size, for buffers that store the file data at the upstream digital computer.

4. The method of claim 3 wherein the upstream digital computer obtains a buffer for storing an amount of file data which is an integral multiple of the extent value by subdividing a larger, preallocated buffer.

5. The method of claim 1 wherein the intermediate and downstream digital computers negotiate the final second MTU size by:
a) the intermediate digital computer transmitting to the downstream digital computer a request to access the file together with a proposed second MTU size for possible use for transfers of file data between the intermediate and downstream digital computers; and
b) the intermediate digital computer receiving from the downstream digital computer the final second MTU size which the downstream and intermediate digital computers use for transfers of file data between the downstream and intermediate digital computers.

6. The method of claim 5 further comprising the step of the intermediate digital computer establishing an extent value, which equals the final second MTU size, for buffers that store the file data at the intermediate digital computer.

7. The method of claim 6 wherein the intermediate digital computer obtains a buffer for storing an amount of file data which is an integral multiple of the extent value by subdividing a larger, preallocated buffer.

8. In a network of digital computers via which a first digital computer thereof accesses through at least one intermediate digital computer a file that is stored at a second digital computer in the network of digital computers; the first digital computer being adapted for retrieving from the second digital computer and for storing a cached image of the file, a method for configuring individual digital computers for efficiently transferring the file through the network of digital computers comprising the steps of:
a) an intermediate digital computer receiving from an upstream digital computer a request to access the file together with a proposed first MTU size for possible use for transfers of file data between the upstream and intermediate digital computers;
b) the intermediate digital computer transmitting to a downstream digital computer a request to access the file together with a proposed second MTU size for possible use for transfers of file data between the intermediate and downstream digital computers;
c) the intermediate digital computer receiving from the downstream digital computer a final second MTU size which the downstream and intermediate digital computers use for transfers of file data between the downstream and intermediate digital computers; and
d) the intermediate digital computer transmitting to the upstream digital computer a final first MTU size which the intermediate and upstream digital computers use for transfers of file data between the intermediate and upstream digital computers.

9. The method of claim 8 further comprising the steps of:
a) the upstream digital computer establishing a first extent value, which equals the final first MTU size, for buffers that store the file data at the upstream digital computer; and
b) the intermediate digital computer establishing a second extent value, which equals the final second MTU size, for buffers that store the file data at the intermediate digital computer.

10. The method of claim 9 wherein:
a) the upstream digital computer obtains a buffer for storing an amount of file data which is an integral multiple of the first extent value by subdividing a larger, preallocated buffer; and
b) the intermediate digital computer obtains a buffer for storing an amount of file data which is an integral multiple of the second extent value by subdividing a larger, preallocated buffer.
